(19) United States
(12) Patent Application Publication
(10) Pub. No.: US 2013/0156555 A1
(43) Pub. Date: Jun. 20, 2013

(54) BRAZE MATERIALS, BRAZING PROCESSES, AND COMPONENTS WITH WEAR-RESISTANT COATINGS FORMED THEREBY

(71) Applicants: David Edwin Budinger, Loveland, OH (US); Jonathan Reid Biberstine, West Lafayette, IN (US)

(72) Inventors: David Edwin Budinger, Loveland, OH (US); Jonathan Reid Biberstine, West Lafayette, IN (US)

(73) Assignee: GENERAL ELECTRIC COMPANY, Schenectady, NY (US)

(21) Appl. No.: 13/326,656

(22) Filed: Dec. 15, 2011

(51) Int. Cl. F03B 11/02; C22C 30/00; B32B 15/02; B05D 3/02; B22F 1/00; C22C 19/07; B05D 7/24

(52) U.S. Cl. 415/182.1; 420/435; 420/436; 420/588; 427/201; 75/228

(57) ABSTRACT

Braze materials, brazing processes, and coatings produced therefrom, for example, a wear-resistant coating suitable for protecting surfaces subjected to wear at high temperatures. The braze material includes first particles formed of a metallic alloy and second particles formed of a cobalt-base braze alloy having a melting point below the melting point of the first particles. The braze alloy consists of, by weight, 3.5 to 15.0% silicon, 2.0 to 6.0% boron, and the balance cobalt and incidental impurities, and the second particles constitute at least 30 up to 90 weight percent of the first and second particles combined. Following a brazing cycle performed on the braze material, a wear-resistant coating is formed in which the first particles are dispersed in a matrix of the braze alloy.

### BACKGROUND OF THE INVENTION

The present invention generally relates to components and materials suitable for use in high temperature applications, such as gas turbine engines and other turbomachinery. More particularly, this invention is directed to braze material compositions and processes for use in the coating, surface build-up, repair, and manufacturing of high temperature components.

Significant advances in high temperature capabilities have been achieved through the formulation of iron-, nickel- and cobalt-base superalloys whose high temperature properties enable components to withstand long exposures at typical operating temperatures within the compressor, turbine, combustor and augmentor sections of high-performance gas turbine engines. Advancements in brazing materials and techniques have also been achieved for use in the fabrication and repair of certain turbomachinery, as well as for the building up surfaces and forming protective coatings. As a nonlimiting example, wear-resistant coatings are required on various surface of turbomachinery, such as exhaust flaps of aircraft gas turbine engines. Brazing techniques generally encompass heating a braze material, typically in the form of a paste, flexible tape or sintered preform containing a braze alloy powder, to a temperature above the melting point of the braze alloy but sufficiently below the melting point of the substrate material being brazed to avoid damage to and/or reducing the desired properties of the substrate material. (As used herein, “melting point” is meant to encompass the incipient melting point for alloys that do not have a true melting point but instead have a melting range.) For example, brazing temperatures are typically limited to avoid grain growth, incipient melting, recrystallization, and/or unfavorable phase formation in substrate materials. For example, René 41, a gamma prime-strengthened nickel-base superalloy, is prone to carbide segregation along grain boundaries if exposed to temperatures above about 2150° F. (about 1175° C.), causing a significant decrease in ductility.

Tribaloy® T800, a cobalt-based hardface alloy commercially available from Deloro Stellite Inc., is a well-know composition used to form a more wear-resistant coating on gas turbine engine components. Because T800 has a very high melting temperature, T800-based wear-resistant coatings formed by braze processes are typically formed by combining a T800 powder with a powder of a braze alloy having a lower melting temperature. The powder mixture is heated to melt only the braze alloy, which upon cooling yields a wear-resistant coating that contains a dispersion of T800 particles in a matrix formed by the braze alloy. Notable but nonlimiting examples of braze alloys include the cobalt-base alloys MAR-M 509B and AMS 4783. These braze alloys have compositions that contain one or more melting point suppressants, such as boron and/or silicon, which form low melting eutectics. Combining MAR-M 509B or AMS 4783 with T800 yields a brazing material that can form wear-resistant coatings at brazing temperatures in a typical range of about 2150 to about 2225° F. (about 1175 to about 1220° C.). If the relative amount of the braze alloy (MAR-M 509B or AMS 4783) is drastically increased to reduce the braze temperature of the braze material to something below 2150° F., the density and substrate bond strength of the resulting wear-resistant coating is generally inadequate for wear applications. Consequently, wear-resistant coatings have not been produced with the T800, MAR-M 509B and AMS 4783 alloy systems at brazing temperatures that can be tolerated by superalloys such as René 41.

Prior attempts to create wear-resistant coatings capable of being brazed at lower temperatures have also included the development of nickel-base braze alloys. While demonstrating high densities and bond strengths, these alloys have not exhibited wear resistance comparable to cobalt-base wear-resistant coatings. The reason for this difference is largely due to a lubricious cobalt oxide (CO₃O₄) that forms at temperatures above 1100° F. (about 600° C.), which improves the wear resistance of cobalt and its alloys.

As an alternative to brazing, wear-resistant coatings can be applied by such methods as thermal spraying, in which case the T800 alloy can be directly deposited onto a substrate surface without the requirement for a braze alloy matrix. However, thermal spray processes require a direct line-of-sight, which may not be possible with certain component configurations, including that of exhaust flaps of gas turbine engines. In contrast, brazing processes are well suited for forming coatings on surfaces that cannot be accessed by thermal spraying and other line-of-sight deposition processes.

In view of the above, it would be desirable if a brazing process could be used to deposit wear-resistant cobalt-base coatings at temperatures below 2150° F. (about 1175° C.), which would enable such coatings to be applied to René 41 and other alloys with similar temperature restrictions. However, to do so braze materials for these coatings would require lower braze temperatures than are currently possible with existing T800-based braze materials.

### BRIEF DESCRIPTION OF THE INVENTION

The present invention provides braze materials, brazing processes, and coatings produced therefrom, particular examples being wear-resistant coatings suitable for protecting surfaces subjected to wear at high temperatures.

According to one aspect of the invention, a braze material includes a plurality of first particles of a metallic alloy having a melting point, and a plurality of second particles of a cobalt-base braze alloy having a melting point below the melting point of the metallic alloy. The cobalt-base braze alloy consists of, by weight, 3.5 to 15.0% silicon, 2.0 to 6.0% boron, and the balance cobalt and incidental impurities, and the second particles constitute at least 30 up to 90 weight percent of the first and second particles combined.

Another aspect of the invention is a process of forming a coating using the braze material described above. The process includes applying the braze material to a surface of a substrate, heating the braze material to melt the second particles but not the first particles to form a molten braze material in which the first particles are dispersed, and then allowing the molten braze material to cool, solidify, and form a solid coating on the surface of the substrate, the solid coating consisting of the cobalt-base braze alloy and the first particles dispersed therein.

Other aspects of the invention include components of an aircraft gas turbine engine having a substrate region and a coating on the substrate region. The coating defines an outermost surface of the component and is more wear resistant than the substrate region. The coating comprises a cobalt-base alloy in which particles are dispersed. The cobalt-base alloy consists of, by weight, 3.5 to 15.0% silicon, 2.0 to 6.0% boron, and the balance cobalt and incidental impurities. At least some of the particles consist of a metallic alloy having a melting point that is higher than the cobalt-base alloy. The cobalt-base alloy constitutes at least 30 up to 90 weight percent of the coating, and the particles constitute at least 10 up to 70 weight percent of the coating.

A technical effect of the invention is the ability to form wear-resistant cobalt-base coatings on substrate surfaces at temperatures below 2150° F. (about 1175° C.). This capability enables the coatings to be formed on alloys that are prone to undesirable grain growth, incipient melting, recrystallization, and/or unfavorable phase formation at temperatures above 1175° C., a nonlimiting example of which is René 41. The coatings can also be formed to incorporate T800 and other cobalt-base alloys as the wear-resistant phase of the coating.

Other aspects and advantages of this invention will be better appreciated from the following detailed description.

### BRIEF DESCRIPTION OF THE DRAWINGS

FIG. 1 represents a fragmentary cross-sectional view of an assembly comprising two components that form a pivot joint, and a wear-resistant coating on one of the components to reduce wear that would otherwise result from relative motion between the components.

FIGS. 2 and 3 are bar graphs representing data from comparative wear tests performed on coating compositions, including wear-resistant coatings of this invention.

### DETAILED DESCRIPTION OF THE INVENTION

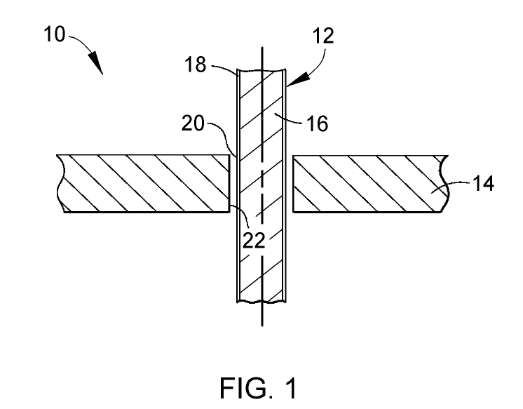

FIG. 1 schematically represents a portion of an assembly 10 having an articulating joint defined by a pin 12 that pivotably supports a component 14 (represented in cross-section) to allow the component 14 to pivot about the axis of the pin 12 (the diametric clearance between the pin 12 and component 14 is exaggerated for purposes of illustration). As a nonlimiting example, the assembly 10 may be an exhaust flap of aircraft gas turbine engine, in which case the pin 12 and component 14 are typically formed of superalloys. As an example, either the pin 12 or component 14 may be formed of the nickel-base alloy Inconel (IN) 718 (nominal composition of, by weight, about 19.0% chromium, about 18.0% iron, about 3.0% molybdenum, about 5.1% niobium, about 0.9% titanium, about 0.5% aluminum, about 0.2% manganese, about 0.2% copper, about 0.04% carbon, and the balance nickel and incidental impurities, while the other may be formed of René 41 (nominal composition of, by weight, 18.0-20.0% chromium, 10.0-12.0% cobalt, 9.0-10.5% molybdenum, 3.0-3.3% titanium, 1.4-1.8% aluminum, 0.06-0.12% carbon, 0.003-0.010% boron, 0-5.00% iron, 0-0.10% manganese, 0-0.50% silicon, with the balance nickel and incidental impurities. Though this combination of materials has been very reliable in gas turbine engine applications, more severe operating conditions can lead to excessive wear rates.

In assemblies of the type represented in FIG. 1, the pin 12 may be subjected to severe wear as a result of the pivoting motion and vibration of the component 14 relative to the pin 12. For this reason, a cylindrical-shaped substrate region 16 of the pin 12 is schematically represented in cross-section as being provided with a coating 20 that overlies the surface 18 of the substrate region 16, with the result that the coating 20 defines the outmost surface of the pin 12 that will contact the component 14. According to a preferred aspect of the invention, the coating 20 is resistant to wear resulting from contact between the pin 12 and component 14, including severe wear conditions that can result from high temperatures and vibration within the operating environment of a gas turbine engine. More particularly, the coating 20 is more wear resistant to rubbing contact with the component 14 than is the material of the pin substrate 16. The coating 20 is shown as being applied to only the substrate region 16 of the pin 12, though it is foreseeable that the coating 20 could instead be deposited on the opposing surface 22 of the component 14. Furthermore, while the coating 20 will be discussed below as serving to provide a wear-resistant surface between the pin 12 and component 14, the coating 20 could be deposited for other purposes, for example, to repair or build-up a surface.

As previously noted, René 41 is known to be prone to carbide segregation along grain boundaries if exposed to temperatures above about 2150° F. (about 1175° C.), which can cause a significant decrease in ductility. Accordingly, if the pin 12 is to be formed of René 41, the coating 20 is preferably deposited so that the temperature of the substrate region 16 does not exceed 1175° C. According to a preferred aspect of the invention, the coating 20 can be initially deposited or applied as a braze material that can be subsequently heated to form the coating 20. In preferred embodiments of the invention, the coating 20 has a composition in which particles are dispersed in a matrix formed of a cobalt-base braze alloy (in other words, the alloy contains more cobalt by weight than any other individual constituent). The braze alloy contains, by weight, 3.5 to 15.0% silicon, 2.0 to 6.0% boron, with the balance cobalt and incidental impurities (which, as used herein, denotes elements that may be difficult to completely eliminate from an alloy due to processing limitations, yet are not present in sufficient quantities to significantly alter or degrade the desired properties of the alloy). More preferably, the braze alloy contains, by weight, 7.3 to 7.7% silicon, 3.6 to 4.0% boron, with the balance cobalt and incidental impurities. A suitable nominal composition for the braze alloy is, by weight, about 7.5% silicon, about 3.8% boron, with the balance cobalt and incidental impurities.

At least some and preferably all of the particles dispersed in the coating 20 are formed of a wear-resistant material. A preferred material for the particles is the aforementioned Tribaloy® T800, and has a composition of, by weight, 27 to 30% molybdenum, 16.5 to 18.5% chromium, 3.0 to 3.8% silicon, up to 1.5% iron, up to 1.5% nickel, up to 0.15% oxygen, up to 0.08% carbon, up to 0.03% phosphorous, up to 0.03% sulfur, and the balance cobalt and incidental impurities. Another suitable cobalt alloy is commercially available from various sources under the name CM 64, an example of which is STELLITE® 694 available from the Deloro Stellite Company, Inc. A suitable composition for a CM 64-type wear-resistant alloy is, by weight, about 26.0 to about 30.0% chromium, about 18.0 to about 21.0% tungsten, about 4.0 to about 6.0% nickel, about 0.75 to about 1.25% vanadium, about 0.7 to about 1.0% carbon, up to 3.0% iron, up to 1.0% manganese, up to 0.5% molybdenum, up to 1.0% silicon, up to 0.10% boron, and the balance cobalt and incidental impurities. Other potential candidates for the wear-resistant particle phase of the coating 20 include, for example, cobalt-base alloys, and particularly cobalt-base alloys that contain significant amounts of chromium, nickel and tungsten, such as a combined chromium, nickel and tungsten content of about 40 to 60 weight percent. Notable examples of such alloys include HS188 (reported nominal composition of, by weight, about 22% nickel, 22% chromium, 14% tungsten, 0.35% silicon, 0.10% carbon, 0.03% lanthanum, up to 3% iron, up to 1.25% manganese, the balance cobalt and incidental impurities), L-605 (reported nominal composition of, by weight, about 20.0% chromium, 10.0% nickel, 15.0% tungsten, and 0.5% carbon, the balance cobalt and incidental impurities), X-40 (reported nominal composition of, by weight, about 25% chromium, 10% nickel, 7.5% tungsten, 1.5% iron, 0.50% manganese, 0.50% silicon, 0.50% carbon, the balance cobalt and incidental impurities), and Mar-M 509 (reported nominal composition of, by weight, about 22.5% chromium, 10% nickel, 7% tungsten, 3.5% tantalum, up to 1.5% iron, up to 0.4% silicon, up to 0.1% manganese, 0.5% zirconium, 0.2% titanium, 0.6% carbon, the balance cobalt and incidental impurities).

The matrix phase of the coating 20 formed by the cobalt-base braze alloy constitutes at least 30 weight percent but not more than 90 weight percent of the coating 20. The particle phase of the coating constitutes at least 10 weight percent and up to about 70 weight percent of the coating 20. In preferred embodiments of the coating 20, the matrix phase formed by the cobalt-base braze alloy constitutes 40 to 55 weight percent of the coating 20, with the balance of the coating 20 being the particle phase. The entire coating 20 preferably has a thickness of at least 25 micrometers, for example, about 100 to about 250 micrometers. Coating thicknesses exceeding 500 micrometers are believed to be unnecessary in terms of wear resistance.

According to a preferred aspect of the invention, the braze material deposited/applied and then heated to form the coating 20 contains a powder of the cobalt-base braze alloy, as well as the wear-resistant particles to be dispersed in the coating 20. Depending on the desired method of application, the braze material can take several forms. For example, the braze material may be a paste, in which case the braze material contains an binder and potentially other constituents capable of providing or promoting a paste-like consistency for the braze material. A paste of the braze material can be applied directly to the pin 12 and then subjected to a brazing cycle. Alternatively, the braze material could be used in the form of a tape, for example, by mixing the wear-resistant particles, a powder of the cobalt-base braze alloy and a binder, and then curing the binder to form a pliable tape. Suitable binders for use in a braze material paste or tape include polymeric binders that are capable of burning off cleanly during brazing, examples of which are water-based organic polymer binders, such as polyethylene oxide (PEO) mixed with water. Other types of binders, and particularly other organic polymeric binders, could foreseeably be used. Another alternative is to form the braze material as a rigid presintered preform by sintering a mixture of the wear-resistant particles and a powder of the cobalt-base braze alloy. A suitable sintering process involves making a tape of the powder mixture or forming a layer of the powder mixture, and then exposing the tape or layer to a temperature above the melting point of the braze alloy so that the particles of the braze alloy melt and, upon cooling, a dense sheet is formed in which the wear-resistant particles are dispersed in a matrix of the braze alloy.

Regardless of its form, the braze material is applied to the surface 18 of the substrate region 16 and then heated to melt the cobalt-base braze alloy without melting the wear-resistant particles. According to a preferred aspect of the invention, the cobalt-base braze alloy has a melting temperature of less than 2150° F. (about 1175° C.), and more preferably within a range of about 2050 to about 2125° F. (about 1120 to about 1160° C.). Brazing is preferably performed in a vacuum or an inert atmosphere and under conditions that avoid distortion of the pin 12 while assuring that the cobalt-base braze alloy is fully molten. A suitable example is to heat the braze material to a temperature about 2050 to about 2125° F. (about 1120 to about 1160° C.), at which the braze material is held for a duration sufficient to ensure that the braze alloy is fully liquified. If a binder is present in the braze material, an intermediate hold can be performed to ensure that the binder is completely burned off. As a result of the brazing cycle, particles of the cobalt-base braze alloy are fully melted to yield a molten braze material in which the wear-resistant particles are dispersed. At the completion of the brazing cycle, the molten braze material is allowed to cool to solidify the braze alloy and form the solid wear-resistant coating 20, in which the wear-resistant particles are dispersed and bonded to the surface 18 of the substrate region 16. The coating 20 may undergo processing to achieve a desirable surface roughness, for example, about 64 micrometers Ra or less.

In an investigation leading to the present invention, wear tests were conducted at a test temperature of about 1100° F. (about 590° C.). Wear specimens were fabricated as block and shoe couples subjected to reciprocating sliding wear utilizing a contact zone of about 2.0×25 mm, with the sliding motion occurring at a frequency of about 25 Hz over a distance of about 1.25 mm in a direction parallel to the smaller dimension of the contact zone. The contact pressure was about 2500 psi (about 17 MPa). The blocks were formed of René 41 and the shoes were formed of either René 41 or IN718. A first baseline couple was a block and shoe formed of René 41 (“R′41/R′41”), and a second baseline couple was a block and shoe formed of René 41 and IN718, respectively (“R′41/IN718”). Two experimental couples (“R′41+Coating/R′41” and “R′41+Coating/IN718”) were tested that were identical to the first and second baseline couples, except the block of each coupled was provided with a wear-resistant coating of T800 particles in a matrix formed of a cobalt-base braze alloy. The coatings were prepared from a braze mixture comprising particles of T800 mixed with a powder of the braze alloy containing, by weight, about 7.5% silicon, about 3.8% boron, with the balance cobalt and incidental impurities. The T800 particles constituted about 52.5 weight percent of the powder mixture, with the balance being the braze alloy. The powder mixture was combined with a binder to form a tape, which was then applied to the experimental blocks and heated to about 1160° C. to burn off the binder and melt the braze alloy. Upon cooling, the resulting coatings had thicknesses of about 0.5 micrometer. The coatings were then surface machined to have a thickness of about 0.25 micrometer.

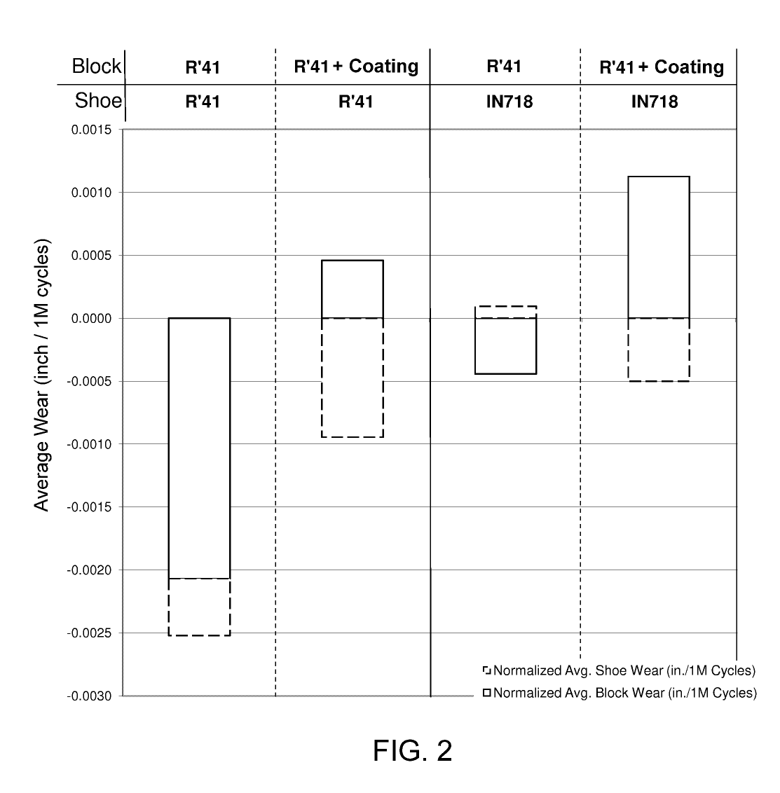

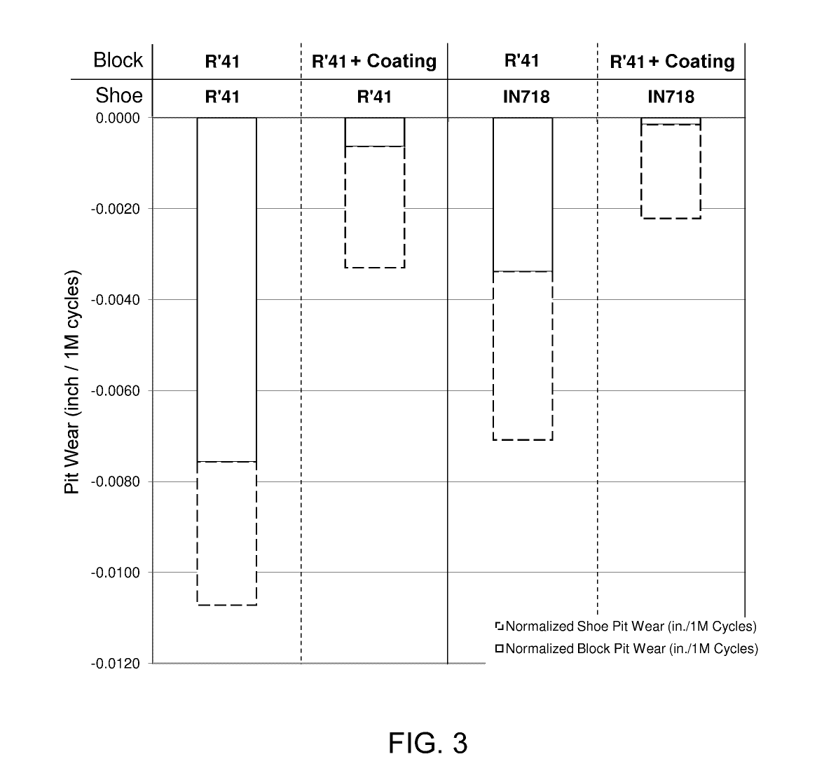

FIGS. 2 and 3 are graphs summarizing data obtained from the investigation, and plot the average wear and pit wear results for the two baseline and two experimental couples. All results are normalized to 1,000,000 cycles. From these results, it can be seen that the experimental couples exhibited an improvement over the baseline couples. In particular, the experimental couples exhibited a reduced amount of wear in terms of their average and/or deepest pit wear measurements. The coatings reduced the wear of the René 41 blocks to essentially insignificant levels. As evident from FIG. 2, some material transfer occurred, resulting in a positive build-up on the coated surfaces of the experimental couples. Though the shoes of the experimental couples exhibited increased average wear, they exhibited equivalent or decreased pit wear relative to the baseline couples.

While the invention has been described in terms of specific embodiments, it is apparent that other forms could be adopted by one skilled in the art. Therefore, the scope of the invention is to be limited only by the following claims.

1. A braze material comprising:
a plurality of first particles of a metallic alloy having a melting point; and
a plurality of second particles of a cobalt-base braze alloy having a melting point below the melting point of the metallic alloy, the cobalt-base braze alloy consisting of, by weight, 3.5 to 15.0% silicon, 2.0 to 6.0% boron, and the balance cobalt and incidental impurities, the second particles constituting at least 30 up to 90 weight percent of the first and second particles combined.

2. The braze material according to claim 1, wherein the cobalt-base braze alloy has a melting temperature of less than 1175° C.

3. The braze material according to claim 1, wherein the cobalt-base braze alloy consists of, by weight, 7.3 to 7.7% silicon, 3.6 to 4.0% boron, and the balance cobalt and the incidental impurities.

4. The braze material according to claim 1, wherein the cobalt-base braze alloy consists of, by weight, about 7.5% silicon, about 3.8% boron, and the balance cobalt and the incidental impurities.

5. The braze material according to claim 1, wherein the second particles constitute about 40 to about 55 weight percent of the first and second particles combined.

6. The braze material according to claim 1, wherein the metallic alloy is a cobalt-base alloy.

7. The braze material according to claim 6, wherein:
the metallic alloy consists of, by weight, 27 to 30% molybdenum, 16.5 to 18.5% chromium, 3.0 to 3.8% silicon, up to 1.5% iron, up to 1.5% nickel, up to 0.15% oxygen, up to 0.03% sulfur, up to 0.03% phosphorus, and up to 0.08% carbon, the balance cobalt and incidental impurities; or
the metallic alloy consists of, by weight, about 26.0 to about 30.0% chromium, about 18.0 to about 21.0% tungsten, about 4.0 to about 6.0% nickel, about 0.75 to about 1.25% vanadium, about 0.7 to about 1.0% carbon, up to 3.0% iron, up to 1.0% manganese, up to 0.5% molybdenum, up to 1.0% silicon, up to 0.10% boron, and the balance cobalt and incidental impurities; or
the metallic alloy has a combined chromium, nickel and tungsten content of about 40 to 60 weight percent.

8. The braze material according to claim 1, wherein the braze material is in the form of a paste and consists essentially of the first and second particles and a binder.

9. The braze material according to claim 1, wherein the braze material is in the form of a tape and consists essentially of the first and second particles and a binder.

10. The braze material according to claim 1, wherein the braze material is in the form of a sintered preform and consists of the first and second particles.

11. A process of using the braze material of claim 1, the process comprising:
applying the braze material to a surface of a substrate region;
heating the braze material to melt the second particles but not the first particles to form a molten braze material in which the first particles are dispersed; and then
allowing the molten braze material to cool, solidify, and form a solid coating on the surface of the substrate region, the solid coating consisting of the cobalt-base braze alloy and the first particles dispersed therein.

12. The process according to claim 11, wherein the solid coating is more wear resistant than the substrate region.

13. The process according to claim 12, wherein the metallic alloy is a cobalt-base alloy and wherein:
the cobalt-base alloy consists of, by weight, 27 to 30% molybdenum, 16.5 to 18.5% chromium, 3.0 to 3.8% silicon, up to 1.5% iron, up to 1.5% nickel, up to 0.15% oxygen, up to 0.03% sulfur, up to 0.03% phosphorus, and up to 0.08% carbon, the balance cobalt and incidental impurities; or
the cobalt-base alloy consists of, by weight, about 26.0 to about 30.0% chromium, about 18.0 to about 21.0% tungsten, about 4.0 to about 6.0% nickel, about 0.75 to about 1.25% vanadium, about 0.7 to about 1.0% carbon, up to 3.0% iron, up to 1.0% manganese, up to 0.5% molybdenum, up to 1.0% silicon, up to 0.10% boron, and the balance cobalt and incidental impurities; or
the cobalt-base alloy has a combined chromium, nickel and tungsten content of about 40 to 60 weight percent.

14. The process according to claim 12, wherein the braze material is heated to a temperature of less than 1175° C. and the substrate region is formed of an alloy whose ductility decreases if heated to a temperature above 1175° C. due to carbide segregation along grain boundaries thereof.

15. The process according to claim 12, wherein the substrate region is a surface region of a component of a turbomachine.

16. A component of an aircraft gas turbine engine, the component comprising:
a substrate region; and
a coating on the substrate region, the coating defining an outermost surface of the component and being more wear resistant than the substrate region, the coating comprising a cobalt-base alloy in which particles are dispersed, the cobalt-base alloy consisting of, by weight, 3.5 to 15.0% silicon, 2.0 to 6.0% boron, and the balance cobalt and incidental impurities, at least some of the particles consisting of a metallic alloy having a melting point that is higher than the cobalt-base alloy, the cobalt-base alloy constituting at least 30 up to 90 weight percent of the coating, the particles constituting at least 10 up to 70 weight percent of the coating.

17. The component according to claim 16, wherein the cobalt-base alloy consists of, by weight, 7.3 to 7.7% silicon, 3.6 to 4.0% boron, and the balance cobalt and the incidental impurities.

18. The component according to claim 16, wherein the metallic alloy of the particles is a cobalt-base alloy and wherein:
the cobalt-base alloy consists of, by weight, 27 to 30% molybdenum, 16.5 to 18.5% chromium, 3.0 to 3.8% silicon, up to 1.5% iron, up to 1.5% nickel, up to 0.15% oxygen, up to 0.03% sulfur, up to 0.03% phosphorus, and up to 0.08% carbon, the balance cobalt and incidental impurities; or
the cobalt-base alloy consists of, by weight, about 26.0 to about 30.0% chromium, about 18.0 to about 21.0% tungsten, about 4.0 to about 6.0% nickel, about 0.75 to about 1.25% vanadium, about 0.7 to about 1.0% carbon, up to 3.0% iron, up to 1.0% manganese, up to 0.5% molybdenum, up to 1.0% silicon, up to 0.10% boron, and the balance cobalt and incidental impurities; or
the cobalt-base alloy has a combined chromium, nickel and tungsten content of about 40 to 60 weight percent.

19. The component according to claim 16, wherein the coating consists of the cobalt-base alloy and the particles dispersed therein, the cobalt-base alloy constitutes at least 30 up to 90 weight percent of the coating, and the particles constitute at least 10 up to 70 weight percent of the coating.

20. The component according to claim 16, wherein the component is part of an exhaust flap assembly.
